(19) United States
(12) Patent Application Publication
(10) Pub. No.: US 2023/0306215 A1
(43) Pub. Date: Sep. 28, 2023

(54) IDENTIFYING WHEN AN IMAGE OF A SYMBOL IS SCANNED IN PLACE OF THE ORIGINAL SYMBOL

(71) Applicant: David Sean Kehoe, Jersey City, NJ (US)

(72) Inventor: David Sean Kehoe, Jersey City, NJ (US)

(21) Appl. No.: 17/705,303

(22) Filed: Mar. 26, 2022

(51) Int. Cl. G06K 7/14

(52) U.S. Cl. CPC G06K 7/1417; G06K 7/1413

(57) ABSTRACT

A method using a “position of scanner” indicator and the scientific principle of “parallax” to establish the originality of the scan of a symbol.

### BACKGROUND

Bar codes, Quick Response (QR) codes, and other types of symbols can be scanned and interpreted by smartphones and other commonly available devices. However, the planar format of these symbols allows any specific instance of these symbols to be easily replicated and makes it difficult to establish whether the symbol being scanned is the original or a copy. For example, it is very easy to photograph a QR code and then to scan the photograph in place of scanning the original QR code itself.

In some uses, it is important to establish that the original symbol is being scanned and not an image of it. A simple example is when QR codes are used to identify particular stations on a night watchman's route. Without other information to establish the location of the scanning device when the QR code image is captured, it cannot be known whether the watchman made his rounds and scanned the original QR codes or, alternatively, made his rounds from the comfort of his chair by scanning previously captured images of the QR codes.

### SUMMARY OF THE INVENTION

The use of symbol scanners that capture an image and then find and process the symbol within the image (e.g., smartphones) makes possible the present invention, which adds a three dimensional, visible indicator to symbols (bar codes, QR codes, etc.) that is used to capture the position of the scanner relative to the symbol and then uses this position of scanner indication along with time and motion to distinguish the original symbol from a copy of the symbol.

### BRIEF DESCRIPTION OF DRAWINGS

No drawings.

### DETAILED DESCRIPTION OF DRAWINGS

No drawings.

### DETAILED DESCRIPTION OF THE INVENTION

The invention comprises a symbol; a “position of scanner” indicator; an image capture device (e.g., a smartphone) that is capable of capturing an image, locating the symbol and indicator, and interpreting them; and the methodology to use this information to interpret the scanner's position relative to the symbol.

When the symbol is scanned, the relative position of scanner can be established by computing the distortion of the symbol's known shape. If the position of the scanner is exactly normal to the plane of the symbol, the relative dimensions of the four sides of the symbol would be proportional to the known size (barring any optical distortion). Any position of the scanner other than normal to the plane of the symbol results in the dimensions relative to the known size to be distorted. However, this same distortion characteristic is true of a copy of the original symbol, and thus, by itself can not be used to determine whether it is the original symbol or a copy being scanned.

The “position of scanner” indicator relies upon the principle of “parallax”, in which the surface of the indicator closest to the scanner moves relative to the plane of the symbol as the position of the scanner changes relative to the symbol.

The symbol is affixed to or otherwise incorporated into a holder that contains the position of scanner indicator. The position of the scanner indicator is positioned in pre-determined location relative to the symbol, with this location information included directly (e.g., within a QR code) or by reference (e.g., using a look-up table accessible by the scanner). Having different indicator locations (relative to the symbol), shapes, colors, sizes, and other characteristics can be used to create a very large number of unique holders, which further ensures the accurate determination of originality.

When the user scans the symbol (by first capturing an image of the symbol), the scanner determines the location of the position indicator (based on the distortion of the symbol) and then calculates the scanner's relative position (based on the relative size and position of the indicator and the symbol). Then, either randomly or as predetermined, the user is instructed to move the scanner in a specific direction or path. A new image is captured and the position indicator's location is once again determined. If the new position does not match expectations, then the symbol is deemed to be a copy.

Once the view is reduced to a two-dimensional image, parallax no longer applies to the position indicator, and so changing the view relative to the copy of the symbol yields a different image than does changing the view relative to the original symbol. Furthermore, using more than one prescribed changes in the position of scanner makes it even more unlikely to be simulated by a pre-collected series of images.

A possible embodiment is the use of a raised border (or frame) around a QR code as the “position of scanner” indicator. As the scanner moves and the image is converted to two dimensions, the distance in the two dimensional representation between the raised border and the edge of the symbol changes disproportionally to the width of the border. Had the scanner been pointed instead to a two-dimensional image of the symbol and indicator, the relative widths would have changed proportionally as the scanner moved. Thus, by determining the change was correctly disproportional, the scanner can be assumed to be scanning the original symbol.

1. A method for determining whether a planar symbol is an original or copy using the scientific principle of parallax.

2. A method for establishing originality of a symbol as said in claim 1 comprising known locations for a symbol and a “position of scanner” indicator.

3. A method for establishing originality of a symbol as said in claim 2 comprising a position of scanner indicator that is on a different than plane than the symbol.

4. A method for establishing originality of a symbol as said in claim 3 comprising a position of scanner indicator with a specific value indicating the relative location of the scanner and that is captured in a two-dimensional image by the scanner.

5. A method for establishing originality of a symbol as said in claim 4 comprising a computational machine for analyzing one or more scans and determine the motion of the scanning device relative to the position of scanner indicator and whether that motion is as requested.
